(19) United States
(12) Patent Application Publication
(10) Pub. No.: US 2003/0129753 A1
(43) Pub. Date: Jul. 10, 2003

(54) Chemical screening method

(76) Inventor: Tu Lee, Monmouth Junction, NJ (US)

Correspondence Address: Richard C. Litman, LITMAN LAW OFFICES, LTD., P.O. Box 15035, Arlington, VA, 22215, US

(21) Appl. No.: 10/038,600

(22) Filed: Jan. 8, 2002

(51) Int. Cl. G01N 31/00

(52) U.S. Cl. 436/4; 436/171; 436/174

(57) ABSTRACT

A high-throughput screening method for identifying the processing conditions for solid dispersion systems. This chemical screening method involves placing a series of different weight (molar) ratios of active ingredient to carrier molecule solutions on flat and reflective substrates, e.g., silicon chips, which are spun-cast and analyzed using various optical microscope and other spectroscopic techniques to determine the optimal dispersion system. Micrographs are taken and analyzed. The physical properties of the specific system are represented by plotting the data on a traditional X axis-Y axis chart to produce an equilibrium phase diagram of temperature versus active ingredient:carrier molecules. The micrographs are also used to produce mosaic phase diagrams as another way to analyze the data. The method and phase diagram are suitable analytical tools for determining optimum microscopic miscibility and chemical compatibility of various solutions.

### BACKGROUND OF THE INVENTION

1. Field of the Invention

The present invention relates to a high-throughput screening method for identifying the processing conditions for solid dispersion systems and constructing the respective phase diagrams.

2. Description of the Related Art

Significant challenges have existed to using traditional techniques for identifying desirable solid dispersion systems and transferring the results to large scale production. Solid dispersion systems generally are formed by dispersing an active ingredient in a carrier molecule and dissolving the combined active ingredient and carrier molecule in a solvent prior to evaporating (removing) the solvent.

This process has clear application to a number of industries, including pharmaceutical, food, ceramic, agrochemical and explosive material development. Specifically, the enhancement of oral bioavailability of poorly water-soluble drugs is always an interest in pharmaceutical development and remains one of the challenges of particle engineering. Traditional techniques such as salt formation, solubilization, particle size reduction and solid dispersion have practical limitations. These limitations include technical inefficiencies with solubility, evaporation and heating processes and the associated expenses.

However, recent developments in the formulation of solid dispersion systems have re-focused interest for its commercial use. Two specific developments with direct application to the pharmaceutical and other industries are the following: 1) the direct filling of solid dispersions into hard gelatin capsules; and 2) the availability of surface-active and self-emulsifying carriers.

One common way to prepare dispersion systems is the solvent process. The principle of the solvent process is to co-dissolve the active ingredient and the carrier molecules in a chosen solvent followed by solvent removal to produce fine powders of the active ingredient. The solvent process is easily coupled with solvent based engineering techniques, such as, spherical crystallization, impinging jet, spray drying, freeze drying, supercritical flow, electrospraying, self-assembly, microcontact printing and biomineralization. These techniques are useful in mixing, making and dispersing the active ingredient into the carrier molecules even down to the molecular level. The physical properties of the active ingredient and the carrier molecules, the choice of solvent, the ratio of active ingredient to carrier molecule and the method of preparation impact the physio-chemical structures of the dispersion. This information may be represented by equilibrium phase diagrams of temperature vs. the weight (molar) ratio of active ingredient to carrier molecules with a plurality of curves showing solubility limits.

Despite advances, major obstacles exist in identifying the process conditions for solid dispersion systems and the construction of a phase diagram for each dispersion system. These obstacles include, but are not limited to the following: 1) the many different combinations of a large number of organic solvents and carriers. e.g., celluloses, starches, saccharides, hydrogenated saccharides, fats, glycerine, gums, lecithins, chitosans, gelatins polymers and surfactants; 2) tedious solvent evaporation processes; and 3) lengthy characterization techniques, e.g., X-ray diffraction (XRD) with time scans, differential scanning calorimetry (DSC) with a heating-cooling cycle, and dissolution test and transmission electron microscopy (TEM), which often involve crushing and pulverizing to produce the resultant films.

Lee, T.; Yao, N.; and Aksay, I. A., “Nanoscale Patterning of Barium Titanate on Block Copolymers,” Langmuir, 13, 3866-3870 (1997) describes a method for forming a nanostructured composite and, specifically, embedding barium titanate crystals in polymers to form a film of the desired periodic pattern. This method uses a spin casting technique to evaporate the solvent in forming the film and a Transmission Electron Microscope (TEM) to analyze the structure of the film's surface. Unlike the use of the optical microscope in the invention, TEM cannot be used to analyze, directly, the film produced on the substrate. Instead, the film must first be removed from the substrate and broken into pieces for placement on the TEM sample holder, and thus this preparation step is inefficient and not suited for automation. Lee et al. is focused on forming nanostructure patterns on films but does not describe a high-throughput screening method for identifying the processing conditions for solid dispersion systems and constructing the respective phase diagrams. Therefore, the Lee et al. method neither produces solid dispersion systems of various active ingredient to carrier molecule weight (molar) ratios nor analyzes the resultant films directly on a silicon wafer chip using an optical microscope.

Similar articles by Luther, E. P.; Chun, C. M.; Lee, T.; and Aksay, I. A., “In-situ Processing of Nanosize Polymer/BaTiO3 Dielectric Films,” Advances In Dielectric Ceramic Materials, 189-193 (1998) and Slamovich, E. B.; and Aksay, I. A., “Structure Evolution in Hydrothermally Processed (<100 Degrees C.) BaTiO3 Films,” J. Am. Ceram. Soc., 79, 239-247 (1996) describe methods for forming a film of BaTiO3 dispersed in a polymer on a substrate. Both methods use a spin casting technique to evaporate the solvent in forming the film and, at a minimum, use X-ray Diffraction (XRD) to analyze the structure of the film's surface. Unlike the use of the optical microscope in the invention, XRD cannot be used to analyze, directly, the thin film spun cast on the substrate. The film must be thick requiring the use of more materials and multiple spins, which is time-consuming and not suited for automation. In addition, both Luther et al. and Slamovich et al. focus on forming BaTiO3 films on a substrate but do not describe a high-throughput: screening method for identifying the processing conditions for solid dispersion systems and constructing the respective phase diagrams. Therefore, neither the Luther et al. nor Slamovich et al. methods produce solid dispersion systems of various active ingredient to carrier molecule weight (molar) ratios nor analyze the resultant films directly on a silicon wafer chip using an optical microscope.

Sekikawa, H; Nakano, M.; and Arita, T., “Inhibitory Effect of Polyvinylpyrrolidone on the Crystallization of Drugs,” Chem. Pharm. Bull., 26, 118-126 (1978) describes a method of evaporating a solvent in vacuo, stirring for crystallization and using XRD to determine the optimal ratio between sulfisoxazole and polyvinylpyrrolidone. For emphasis, XRD requires that the thick film or the crystals, as in this situation, first be removed or lifted from the beaker prior to sample preparation for XRD. This additional step is inefficienct and, consequently, hinders automation. Sekikawa et al. is also focused on determining the inhibitory effect polyvinylpyrrolidone has on crystallization of the drug but does not describe a high-throughput screening method for identifying the processing conditions for solid dispersion systems and constructing the respective phase diagrams. Therefore, the Sekikawa et al. method neither produces solid dispersion systems of various active ingredient to carrier molecule weight (molar) ratios using spin-casting nor analyzes the resultant films directly on a silicon wafer chip using an optical microscope.

Similar to the previous reference, Fujii, M.; Terai, H.; Mori, T.; Sawada, Y.; and Matsumoto, M., “The Properties of Solid Dispersions of Indomethacin, Ketoprofen and Flurbiprofen in Phosphatidylcholine,” Chem. Pharm. Bull., 36, 2186-2192 (1988) describes the properties of certain solid dispersions prepared by a method of evaporating a solvent in vacuo, crushing crystals in an electric coffee mill and using XRD to determine the optimal ratio between different drugs and phosphatidylcholine, i.e., the analog to the surfactant/polymer. As indicated above, XRD requires that the crystals or thick film be removed or lifted from the slide or beaker and pulverized in preparation for XRD, which is inefficient and not suited for automation. Further, Fujii et al. is focused on determining the properties of the solid dispersions of certain drugs with a specific surfactant/polymer and concludes that solid dispersion in the specific surfactant/polymer improve the utility of poorly water soluble drugs. However, Fujii et al. does not describe a high-throughput screening method for identifying the processing conditions for solid dispersion systems and constructing the respective phase diagrams. Therefore, Fujii et al. neither describes a method to produce solid dispersion systems of various active ingredient to carrier molecule weight (molar) ratios using spin-casting to evaporate the solvent nor analyzes the resultant films directly on a silicon wafer chip using an optical microscope.

Finally, Chiou, W. L.; and Riegleman, S., “Preparation and Dissolution characteristics of Several Fast-Release Solid Dispersions of Griseofulvin,” J. Pharm. Sci., 58, 1505-1509 (1969) describes the optimal drug to carrier ratio of specific solid dispersions of griseofulvin, i.e., the drug, and different polymers, using dissolution performance. Preparation of the solid dispersions use, some or all of, the steps of mixing, heating, evaporating, and pulverizing along with a variety of traditional spectrophotometric techniques, including Ultraviolet (UV) and fluorescence. None of the preparation methods use either a spin casting technique to evaporate the solvent in forming the film or an optical microscope to analyze, directly, the film. UV, IR and fluorescent spectrophotometric techniques like the subsequently developed XRD require that the crystals or film be removed from the slide or beaker and pulverized in preparation for using the specific spectrophotometric technique, and thus is inefficient and not suited for automation. Further, Chiou et al. is focused on determining the dissolution properties of the solid dispersions of griseofulvin (GRIS) and concludes that the solid dispersions in the specific polymers (carriers) chosen are faster than GRIS in succinic acid, and thus require greater study. Chiou et al. does not describe a high-throughput screening method for identifying the processing conditions for solid dispersion systems and construct the respective phase diagrams. Therefore, Chiou et al. neither describes a method to produce solid dispersion systems of various active ingredient to carrier molecule weight (molar) ratios using spin-casting nor analyzes the resultant films directly on a silicon wafer chip using an optical microscope.

None of the above inventions and patents, taken either singularly or in combination, is seen to describe the instant invention as claimed. Thus a chemical screening method solving the aforementioned problems is desired.

### SUMMARY OF THE INVENTION

The invention is a high-throughput screening method for identifying the processing conditions for solid dispersion systems. A series of different weight (molar) ratios of active ingredient to carrier molecule solutions are placed on flat and reflective substrates, e.g., silicon chips, which are spun-cast and analyzed using various optical microscope and other spectroscopic techniques to determine the optimal dispersion system. Micrographs are taken and analyzed. The physical properties of the specific system are represented by plotting the data on a traditional X axis-Y axis chart to produce an equilibrium phase diagram of temperature versus active ingredient:carrier molecules. The micrographs are also used to produce mosaic phase diagrams as another way to analyze the data. The method and phase diagram are suitable analytical tools for determining optimum miscibility and chemical compatibility of various solutions.

Accordingly, it is a principal object of the invention to provide an easy to use and accelerated screening method for identifying the processing conditions for solid dispersion systems.

It is another object of the invention to provide a high-throughput method for determining optimal crystallization, miscibility and chemical compatibility of specific ratios of active ingredients and carriers in solution.

It is a further object of the invention to be performed using an optical microscope, a scanning electron microscope, RAMAN microscopy or infrared microscopy, instead of using the lengthy characterization techniques of X-ray diffraction, differential scanning calorimetry and other traditional spectrometric techniques.

Still another object of the invention is to provide a method for preliminary screening other solvent based systems in the fabrication of the composite of active ingredients with a polymer.

Another object of the invention is to provide an efficient method to generate data for constructing related equilibrium phase diagrams and mosaic phase diagrams of the solid dispersion systems.

It is an object of the invention to be automated and integrated with other analytical techniques and to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block-diagram of a polymer screening method.

FIG. 2 is a side view of mixture placement on a spin-cast.

FIG. 3 is a perspective view of a solid dispersion film formed on a substrate.

FIG. 4 is a side view of light reflecting off a solid dispersion film and substrate.

FIG. 5 is a typical equilibrium phase diagram.

Similar reference characters denote corresponding features consistently throughout the attached drawings.

FIG. 6 is a digital picture of sulfisoxazole on a silicon wafer (scale bar: 5 mm).

FIG. 7 is an optical micrograph of sulfisoxazole on a silicon wafer (scale bar 100 micro m).

FIG. 8 is a digital picture of polyvinylpyrrolidone on a silicon wafer (scale bar: 5 mm).

FIG. 9 is an optical micrograph of polyvinylpyrrolidone on a silicon wafer (scale bar: 100 micro m).

FIG. 10 is an optical micrograph of 1:1 sulfisoxazole/polyvinylpyrrolidone on a silicon wafer (scale bar: 5 mm).

FIG. 11 is an optical micrograph of 1:10 sulfisoxazole/polyvinylpyrrolidone on a silicon wafer (scale bar: 100 micro m).

FIG. 12 is an optical micrograph of 1:5 sulfisoxazole/polyvinylpyrrolidone on a silicon wafer (scale bar: 100 micro m).

FIG. 13 is an optical micrograph of 1:3 sulfisoxazole/polyvinylpyrrolidone on a silicon wafer (scale bar: 100 micro m).

FIG. 14 is an optical micrograph of 1:1 sulfisoxazole/polyvinylpyrrolidone on a silicon wafer (scale bar: 100 micro m).

FIG. 15 is an optical micrograph of 3:1 sulfisoxazole/polyvinylpyrrolidone on a silicon wafer (scale bar: 100 micro m).

FIG. 16 is an optical micrograph of 5:1 sulfisoxazole/polyvinylpyrrolidone on a silicon wafer (scale bar: 100 micro m).

FIG. 17 is an optical micrograph of 10:1 sulfisoxazole/polyvinylpyrrolidone on a silicon wafer (scale bar: 100 micro m).

FIG. 18 is an optical micrograph of 20:1 sulfisoxazole/polyvinylpyrrolidone on a silicon wafer (scale bar: 100 micro m.

### DETAILED DESCRIPTION OF THE PREFERRED EMBODIMENT

The present invention is an accelerated chemical screening method used for identifying the processing conditions for solid dispersion systems and, more particularly, determining optimal crystallization, miscibility and chemical compatibility of specific ratios of active ingredients and carrier molecules, such as, polymers and other compounds, in solution.

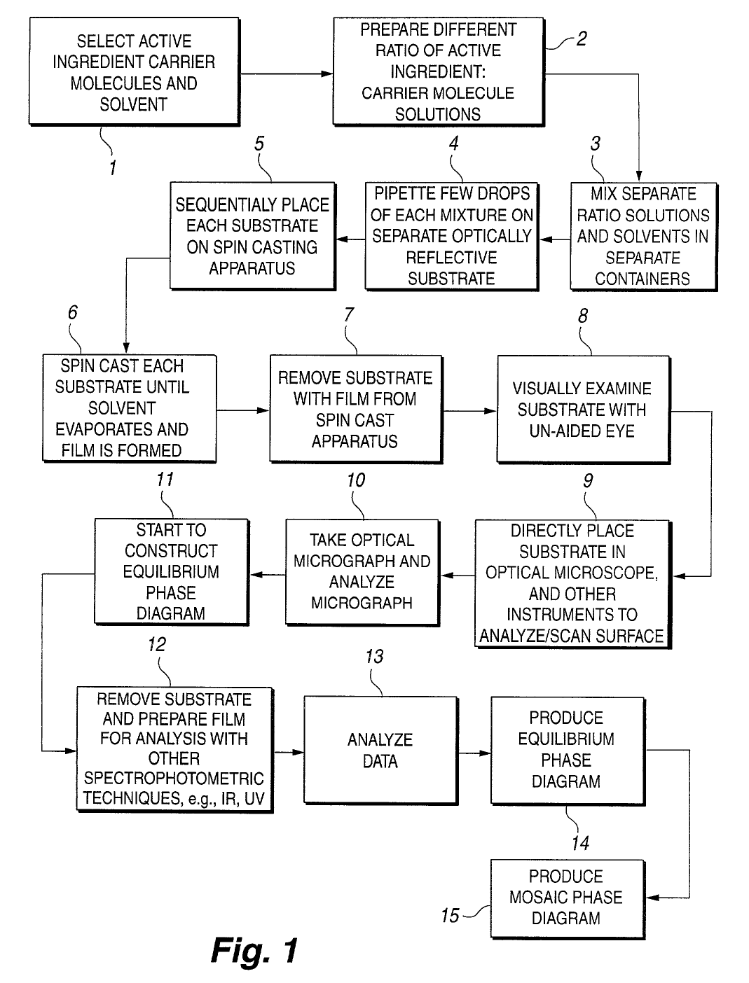

A preferred embodiment of the present invention, referring to flow-diagram form in FIG. 1, shows the chemical screening method. In step 1, an active ingredient and carrier molecule are selected for testing. In a preferred embodiment, the active ingredient can be a variety of organic or inorganic crystalline chemical compounds. Similarly, a variety of carrier molecules are available but in the preferred embodiment the following are used: cellulose, starches, saccharides, hydrogenated saccharides, fats, glycerine, gums, lecithins, chitosans, gelatins, polymers and surfactants.

Next, step 2, one selects a solvent to co-dissolve the active ingredient and the carrier molecule. A variety of solvents are available but in the preferred embodiment the following are most commonly used: water; N,N-Dimethylformamide (DMF); N,N-Dimethylacetamide (DMA); methyl sulfoxide (DMSO), acetone; acetonitrile; methanol; ethanol; isopropanol; n-butanol; tetrahydrofuran (THF); 4-methyl-2-pentanone (MIBK); 2-butanone (MEK); toluene; heptane; cyclohexane; ethyl acetate; n-butyl acetate; isopropyl acetate; and 2-methyltetrahydrofuran. After the selection process, step two further involves preparing a series of solutions containing different weight (molar) ratios of the active ingredient to carrier molecule using conventional laboratory techniques.

Step 3 involves separately mixing a plurality of the active ingredient to carrier molecule solutions with the chosen solvent. In the preferred embodiment, the typical weight (molar) ratios of the active ingredient to carrier molecule are as follows: 1:10; 1:9; 1:8; 1:7; 1:6; 1:5; 1:4; 1:3; 1:2; 1:1; 2:1; 3:1; 4:1; 5:1; 6:1; 7:1; 8:1; 9:1; and 10:1. The typical maximum concentration of the solution of the active ingredient and carrier molecule is predetermined by the least soluble of either the active ingredient or the carrier molecule in a chosen solvent at a given temperature and pressure. All of these solutions are preferably prepared in separate test tubes, scintillating vials or volumetric flasks. In the preferred embodiment, the active ingredient and carrier molecule are completely co-dissolved in a chosen solvent normally under a temperature range of 0(degree sign)C. to the lowest temperature among the following three conditions: 1) the boiling point of the solvent; 2) the melting point of the active ingredient; or 3) the melting point of the carrier molecule. The pressure is substantially one atmosphere. Step 4, as depicted in FIG. 1 and illustrated in FIG. 2, involves placing a few drops of the first mixture near the center of a silicon wafer chip using a pipette and conventional preparation techniques. Film thickness is controlled by the rotational speed of the silicon wafer chip and by the concentration of the solution. A solid dispersion system at a different temperature and/or in a different gaseous environment can be formed by subjecting the spun cast film to a hot-stage and/or environmental cell respectively.

Step 5 involves repeating step 4 for each mixture and thus generating a plurality of silicon wafer chips each supporting different weighted (molar) ratio mixtures in preparation for the spin-casting, step 6. A significant novel feature of this invention is placing each weighted mixture on a silicon wafer chip and using the silicon wafer chip as the platform for performing the analysis. This approach contrasts with the conventional art of making the mixture in solution, evaporating solvent in-vacuo or by natural convection, and crushing and pulverizing the crystals of film in preparation for X-ray diffraction and/or spectroscopic. In a preferred embodiment, the silicon wafer chip is used because the chip's flat surface in conjunction with the reflective nature of the silicon makes optical imaging in a reflective mode easier. In particular, the flatness and reflectivity of a silicon wafer chip enhances both constructive and destructive interference of a light wave propagating through the film whereas direct optical imaging on the glass slide is not possible. In a preferred embodiment, non-conventional or conventional flat silicon wafer chips without indentations are used with the following characteristics: 1) a 100 nm. thick gold surface coating is required for the dielectric measurement across the film; 2) the dimensions are approximately 2 cm.×2 cm.; and 3) the thickness can vary. A new piece of silicon wafer chip is needed for each mixture (weight or molar ratio). In an alternate embodiment, other reflective surfaces with characteristics similar to those exhibited by silicon wafer chips as discussed above may be used.

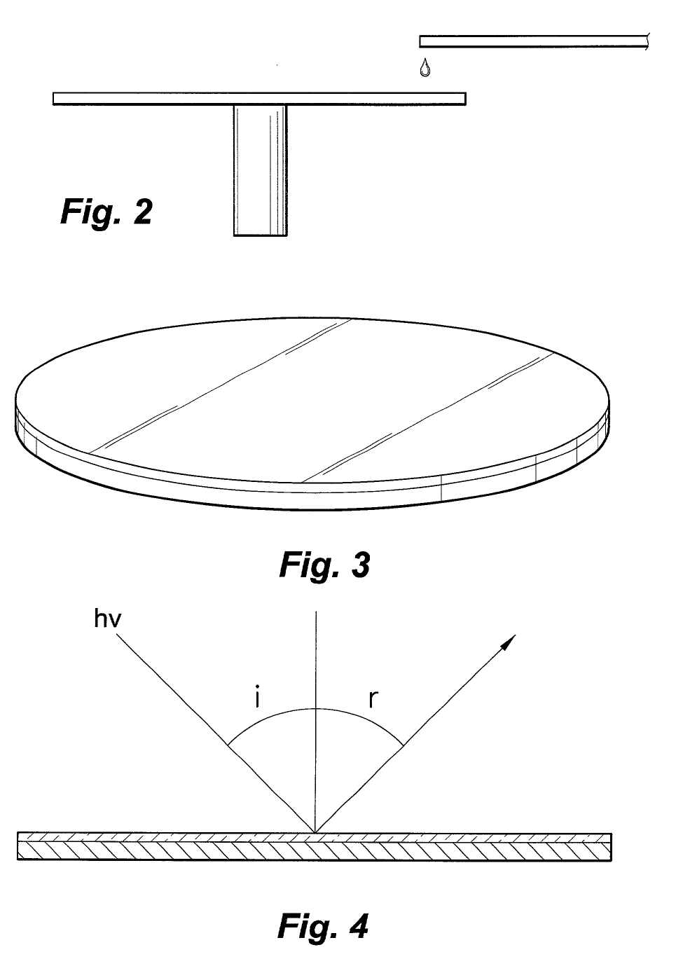

Step 6, as depicted in FIG. 2 and illustrated in FIG. 3, involves placing each silicon wafer chip on a conventional spin-casting apparatus. Each chip is spun cast one at a time. A robotic arm and liquid dispenser can be employed at this point for this repetitious step. The spin casting apparatus is conventionally operated and the silicon wafer chip is spun until the solvent has evaporated leaving a solid dispersion film. Generally, the solvent should evaporate in approximately the range of two (2)-five (5) seconds. The spin apparatus is of the type of spin coaster known as Model CB 15 manufactured by Headaway Research, Inc. of Garland, Tex., where the rotational speed of the apparatus in the preferred embodiment ranges from zero (0)-five thousand (5,000) revolutions per minute. In the preferred embodiment, the spin-casting generally occurs under the following conditions: ambient room temperature and one (1) atmosphere of pressure. These conditions are maintained by performing the spin casting under a conventional vented laboratory hood where the excess amount of solution is spun away by centrifugal force and the remaining solvent is evaporated by forced convection near the rotating surface. Please note that the air flow rate in the hood is not critical to the invention.

Step 7 involves removing the silicon wafer chip from the spin cast apparatus where it is ready for immediate examination. In contrast, and for emphasis, the generation of evaporated samples using traditional techniques as discussed above and the conventional art uses traditional characterization techniques, e.g., X-ray diffraction and differential scanning calorimetry. These techniques, which do not use silicon wafers, require further preparation of the samples by lifting the samples or film off the beaker or other container as well as crushing and pulverizing the material to form the desired shape and form prior to examination. In the preferred embodiment, all the chips are prepared at a given temperature according to Step seven prior to performing the micrograph analysis. This process is done so all desired chips are sequentially produced and separately analyzed via the optical micrograph, RAMAN micrograph or infrared micrograph.

Step 8 involves visually analyzing the resultant film of the solid dispersion system on the silicon wafer chip to determine the morphology, micro-phase separation and crystallinity. Further, a photograph is made of the film on the silicon wafer chip using conventional photographic techniques generally at ambient room temperature and one atmosphere of pressure. The above process is repeated to produce a plurality of silicon wafer chips each at different weight (molar) ratios of active ingredient to carrier molecule.

Step 9, in the preferred embodiment, involves using spectrometric techniques for directly analyzing the film on the silicon wafer chip without having to further remove or process the film. The current technology uses optical microscopes, scanning electron microscopes, RAMAN microscopes, infrared microscopes to perform this task. In the preferred embodiment, an individual silicon wafer chip is directly placed in an optical microscope for analysis and an optical micrograph is taken of each chip at the same constant temperature. In the alternate embodiment, other spectrometric instruments may be used so long as the instruments have similar optical and electromagnetic characteristics as the current technologies as discussed above and below, e.g., optical microscopes, scanning electron microscopes and RAMAN microscopes, which work directly on reflective surfaces, e.g., the silicon wafer chip.

FIG. 4 depicts the light (electromagnetic) wave, hv, coming in at the angle of incidence, i, and leaving at the angle of reflection, r. Diffuse (scattered) reflection results when a beam of light strikes an irregular surface and different portions of incident light are reflected at different angles. Since the silicon wafer substrate is flat and the thin film surface is more irregular, the use of a flat substrate in the background can enhance the morphological contrast of the film. In addition, although not claiming to be limited to one theory, the following theory is presented. By using the vertical illuminators (reflective mode, i.e., the light source and the lens are above the specimen) on the microscope to minimize a combination of total reflection and refraction, good resolving power can be achieved (Walter C. McCrone, Lucy B. McCrone and John Gustav Delly, “Resolving Power and Illumination,” Chapter IV in “Polarized Light Microscopy,” 11th ed., (McCrone Research Institute, Illinois, 1999) pp. 27-48.

In Step 10, each chip is micrographed and analyzed to determine if crystals are slightly visible against the background, 10, preferrably, at a magnification of 125×. If visible for a particular film/chip, then this event represents the separation/dissolution phase boundary for the particular ratio of active ingredient to carrier molecule at the given temperature. In step 11, this data point is plotted on a temperature versus ratio chart, which starts the construction of the equilibrium phase diagram.

The above process is repeated for a plurality of different temperatures of interest to produce a series of micrographs where the results are plotted on the same temperature versus ratio chart. In the preferred embodiment, the temperatures to be used vary from zero (0) degrees celsius to the melting point of the active ingredient or the melting poirnt of the carrier molecule whichever is lower, but the preferable temperature is ambient room temperature.

The chip is further analyzed to determine the following: a) whether phase separation exists microscopically. Phase separation generally occurs when the active ingredient and the carrier molecule are immiscible or the active ingredient is crystallized or the carrier molecules are crystallized or both the active ingredient and the carrier molecules are crystallized; b) the extent of crystallization formed by the active ingredient and/or the carrier molecules; and c) the ratio(s) of the active ingredient to the carrier molecule at a given temperature and pressure (substantially at one atmosphere pressure), below which microscopic phase separation does not exist and above which either phase separation occurs or detectable crystals are formed. This analysis is used to find the point where the crystals are seen against the background.

In Steps 12 and 13, ellipsometry also is used to determine the film thickness. Film thickness is important for XRD time scans and other spectroscopic characterizations. Film thickness in general can be engineered by adjusting the rotational speed and solution concentration. In the preferred embodiment, Steps 12 and 13, are separate activities.

The silicon wafer chip is further analyzed by sequentially analyzing the film using conventional techniques including the following: spectroscopy for crystallinity; polymorphism; chemical analysis and elemental distribution profile; atomic force microscopy for surface morphology and crystal hardness; electron microscopy for sub-micron phase separation; dielectric measurement for special connectivity of chemical components; and thermal analysis for the degree of miscibility.

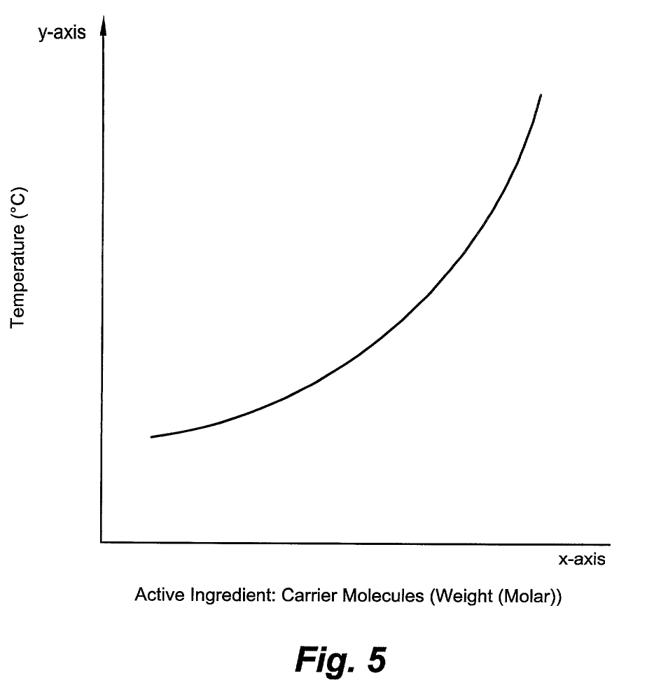

Upon completing the above analysis, in Step 14, the data generated from the various molar ratio mixtures is combined and used to construct an equilibrium phase diagram, as illustrated in FIG. 5, of the solid dispersion systems for the particular active ingredient, carrier molecule and solvent, 14. The equilibrium diagram is used to determine controllable parameters such as temperature(s) and compostion(s) as required to obtain: (a) crystalline phase of active ingredient and amorphous solution of active ingredient and carrier molecule; (b) amorphous solution of active ingredient and carrier molecule; (c) crystalline phase of carrier molecule and amorphous solution of active ingredient and carrier molecule; and (d) crystalline phase of active ingredient and crystalline phase of carrier molecule. More specifically, the equilibrium phase diagram is composed of an X axis and a Y axis. The Y axis is vertically oriented and the X axis is horizontally oriented and the two meet forming a perpendicular intersection. Temperature (in Celsius) is plotted on the Y axis and the active ingredient to carrier ratios are plotted on the X axis (and is numbered). By plotting the data, a plurality of curves showing solubility limits are graphed. These curves are the boundaries of regions: (a) crystalline phase of active ingredient and amorphous solution of active ingredient and carrier molecule; (b) amorphous solution of active ingredient and carrier molecule; (c) crystalline phase of carrier molecule and amorphous solution of active ingredient and carrier molecule; and (d) crystalline phase of active ingredient and crystalline phase of carrier molecule. Finally, the results using one solvent can be compared against the results produced by using the above method on the same active ingredient to carrier ratio systems with a different solvent.

In Step 15, in a preferred embodiment, a mosaic phase diagram is formed using the series of individual micrographs taken at a given temperature. The individual micrographs are place horizontally next to each other starting with the lowest to highest weight ratio, that is, left to right across the X-axis of the equilibrium phase diagram. The first series of optical micrographs are placed at the bottom of the graph to correspond to the initial and lowest constant temperature chosen. Afterwards, the next series of optical micrographs are also place horizontally across the equilibrium phase diagram from lowest to highest ration. This series is taken at a higher constant temperature so this series is higher up the Y axis (temperature), and thus the bottom of these micrographs touch the top of the first series of optical micrographs. This process is repeated for each series of micrographs at each higher constant temperature until all micrographs have been placed on the graph. The result is a mosaic phase diagram where one looks at the morphology shift from a uniform texture to a mottle of particles, which corresponds with the point of solubility. In alternate embodiments, mosaic phase diagrams could also be constructed with X-ray diffractograms (peak intensity and peak shift), RAMAN spectra (peak intensity and peak shift), infrared spectra (peak intenisty and peak shift), atomic force micrographs (morphology shift), electron micrographs (morphology shift), dielectric constants (value shift) and thermal analytical diagrams (peak shift).

Finally, the above process, which includes sample loading, sample analyses, data collection, data processing and data plotting, in an alternate embodiment, may be automated using a variety of robotic techniques and run by specific software. In another embodiment, the above techniques may be integrated with other analytical techniques.

### EXAMPLE 1

The invention was tested on the sulfisoxazole/polyvinylpyrrolidone system in ethanol where sulfisoxazole was the active ingredient and polyvinylpyrrolidone was the carrier of choice. The total time required to evaporate ethanol for each sample was less than 30 seconds. Based on separate experiments by conventional methods, the solubility of sulfisoxazole and polyvinylpyrrolidone in ethanol was determined to be, respectively, 16 mg/ml and 46 mg/ml. This information is important because these solubility parameters determine the minimum amount (volume) of solvent required to co-dissolve the active ingredient and the carrier molecules. Next eight ethanol solutions were prepared of different sulfisoxazole to polyvinylpyrrolidone weight (molar) ratios.

| Ratio | Sulfisoxazole (mg) | Polyvinylpyrrolidone (mg) | Ethanol (ml) |
|---|---|---|---|
| 1:10 | 1 | 10 | 0.3 |
| 1:5 | 2 | 10 | 0.4 |
| 1:3 | 3.3 | 10 | 0.5 |
| 1:1 | 10 | 10 | 0.9 |
| 3:1 | 30 | 10 | 2.1 |
| 5:1 | 50 | 10 | 3.4 |
| 10:1 | 100 | 10 | 6.5 |
| 20:1 | 200 | 10 | 12.8 |

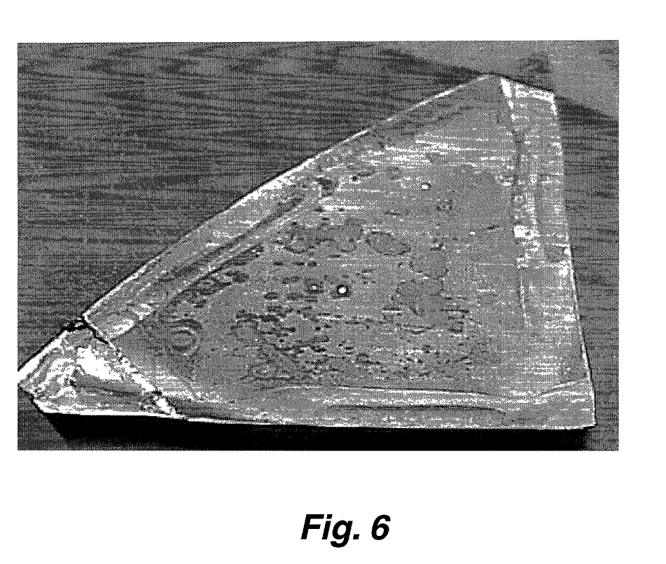

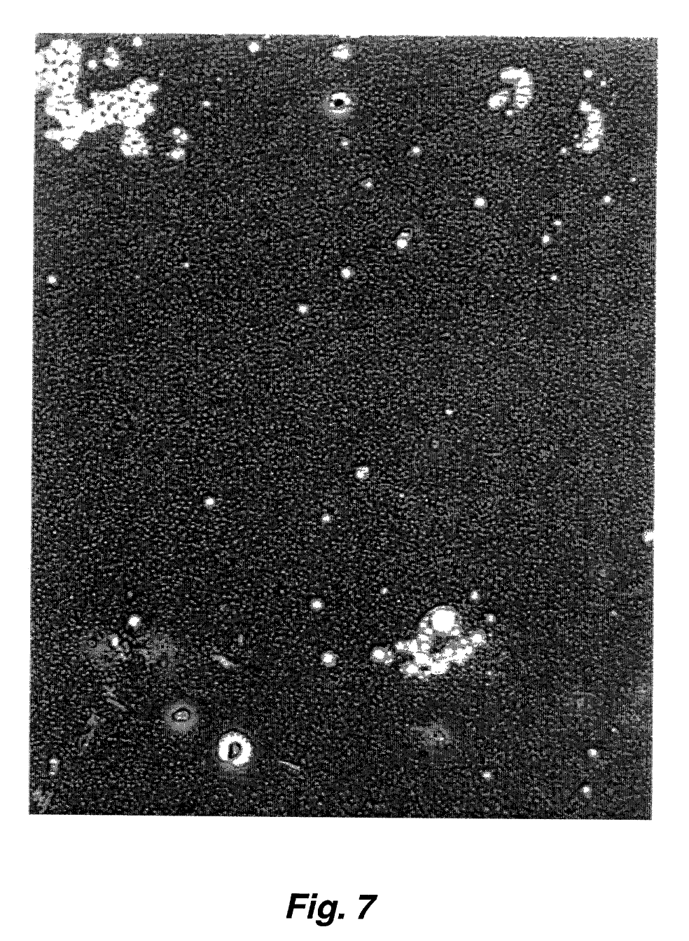

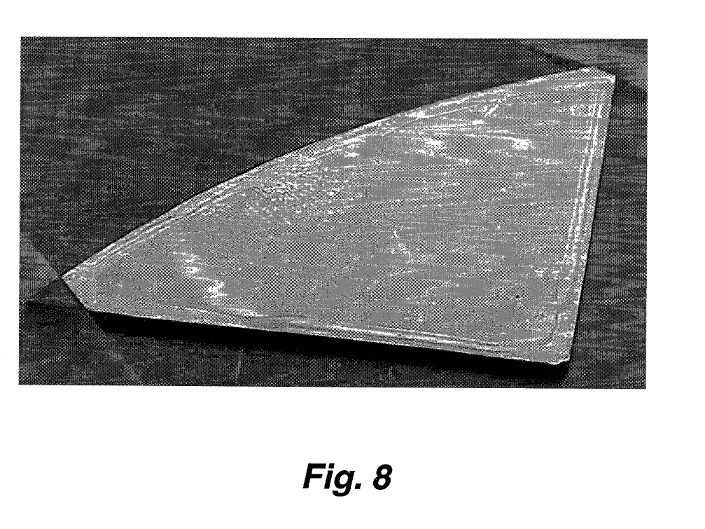

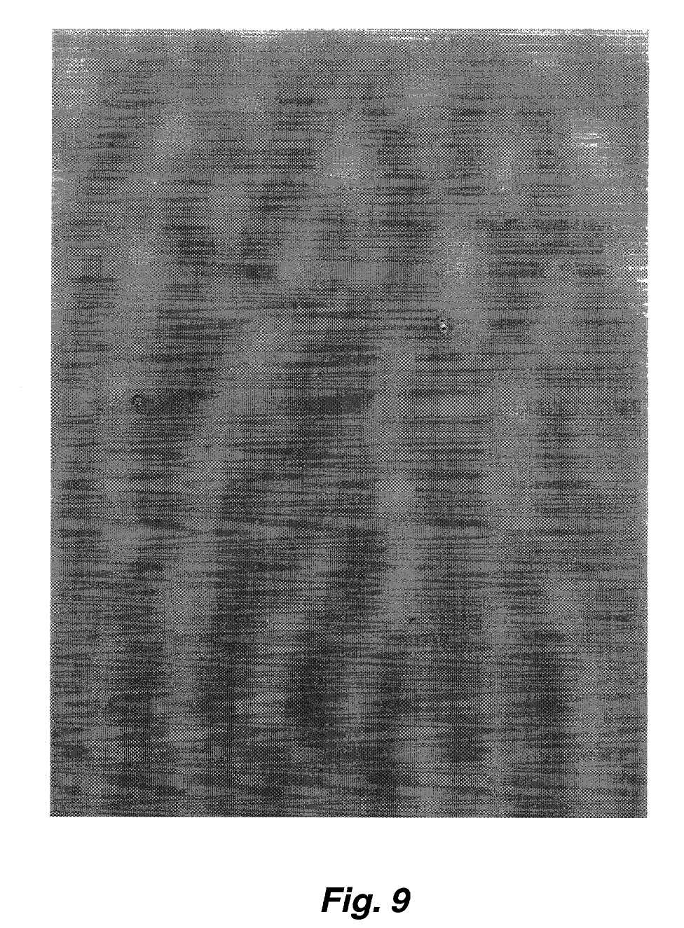

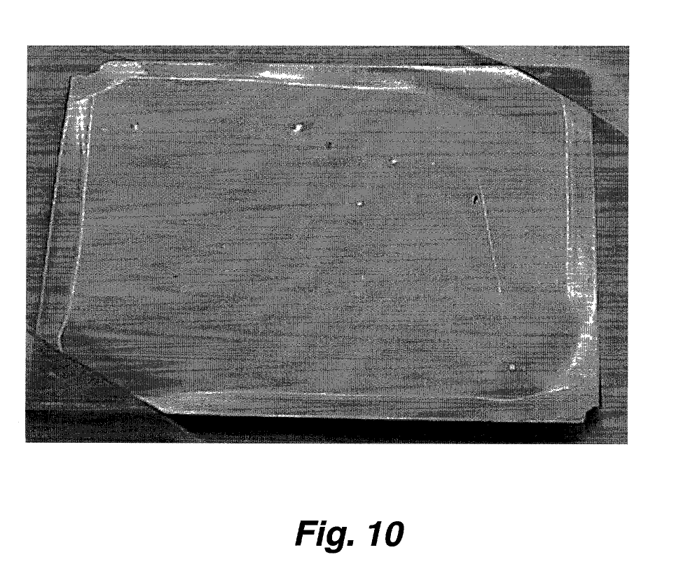

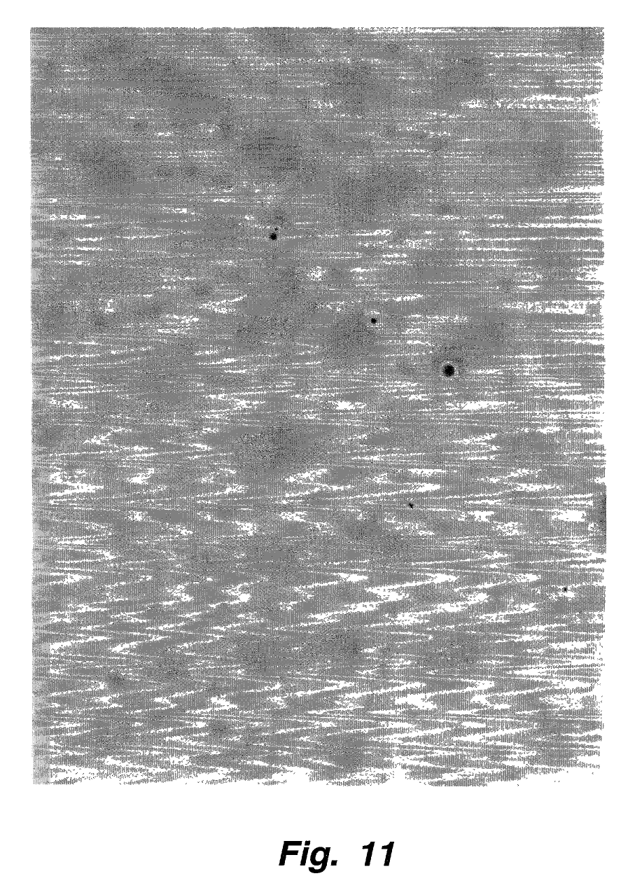

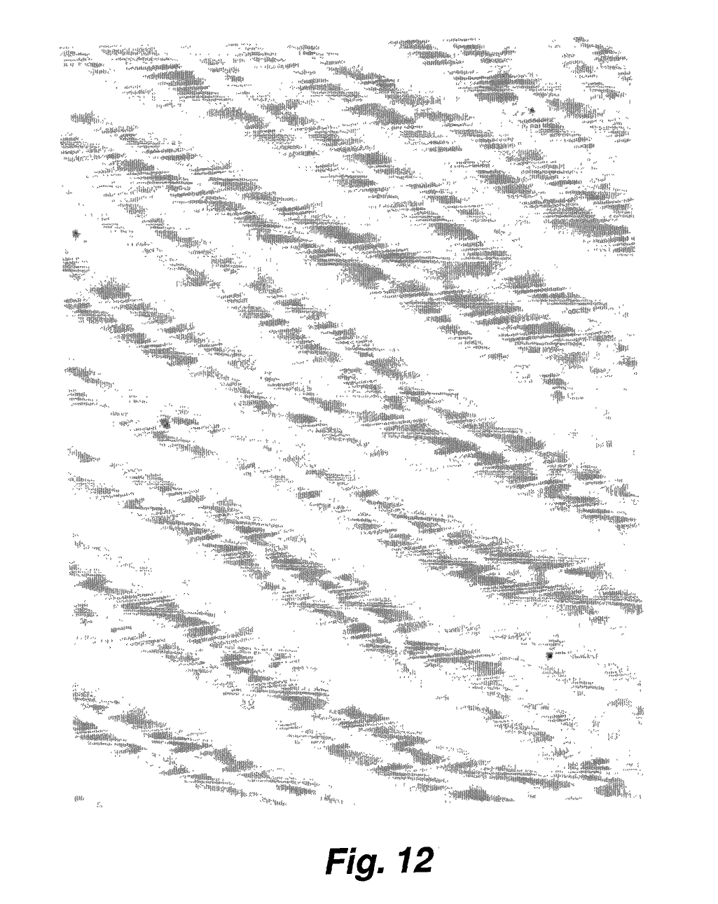

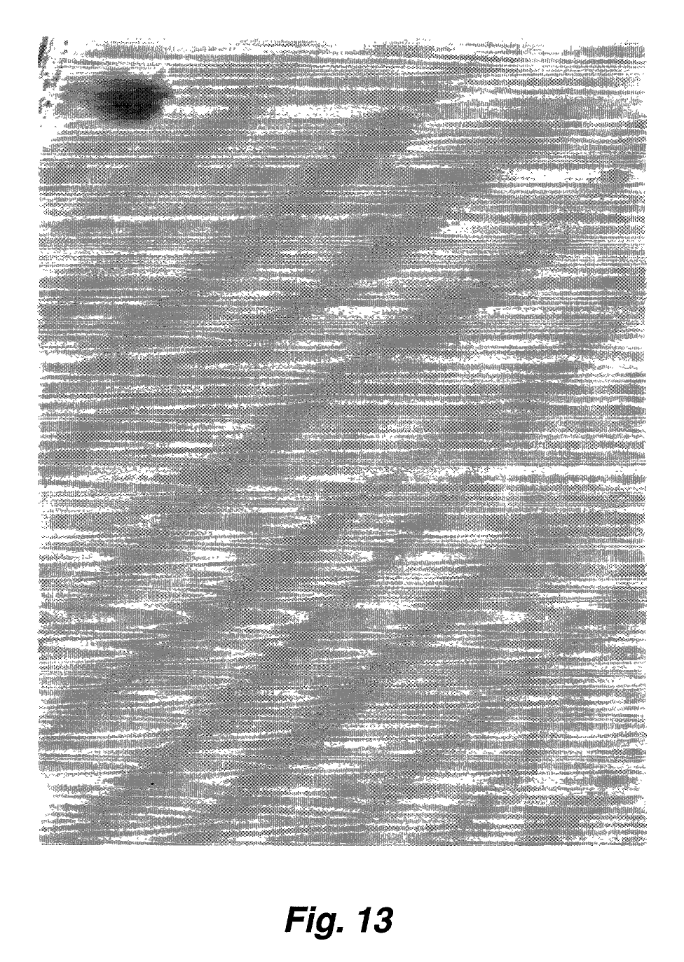

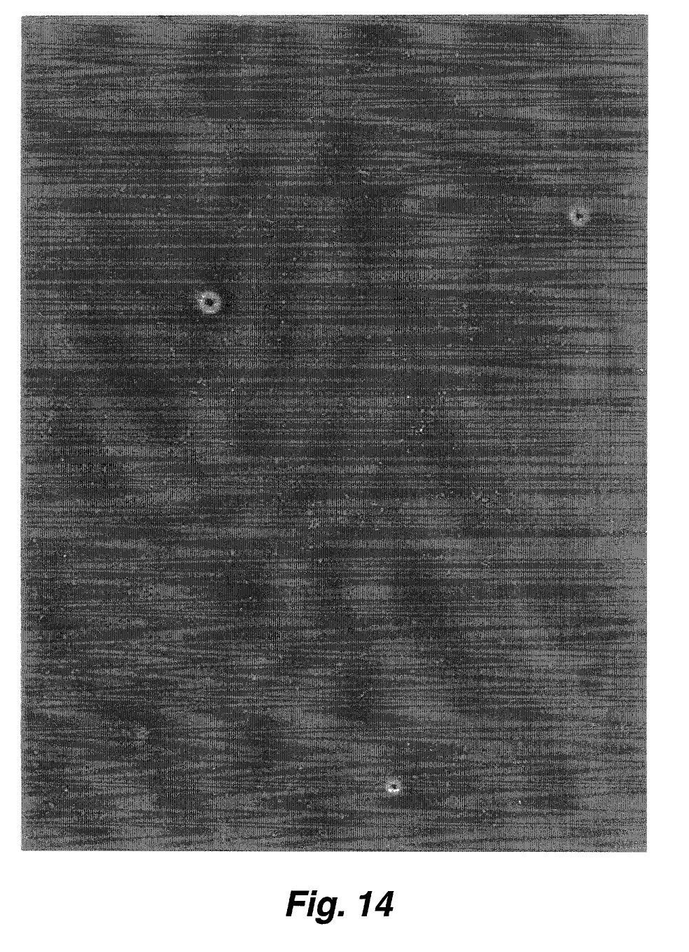

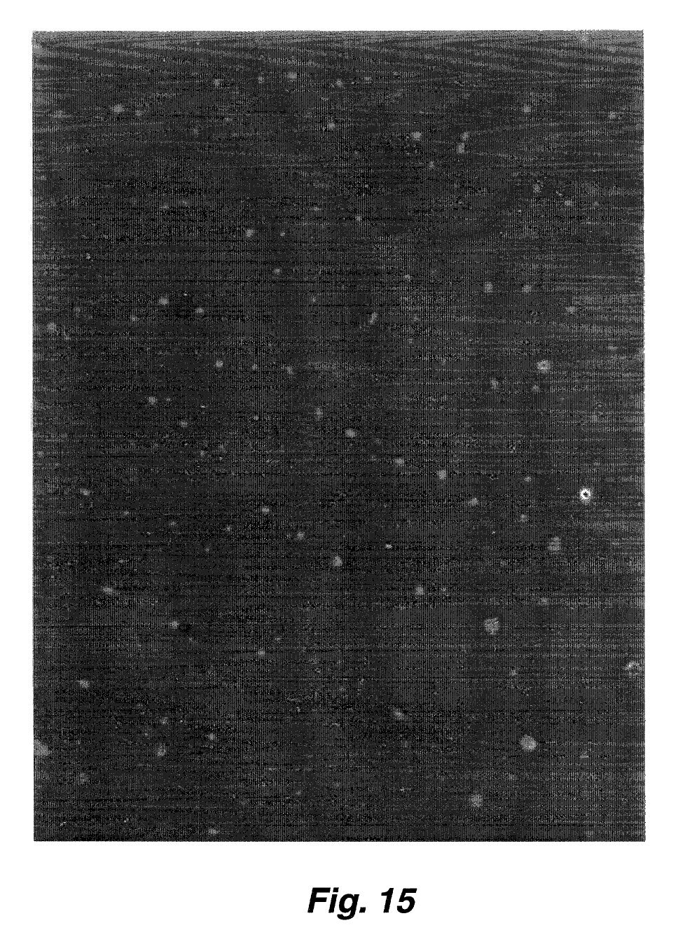

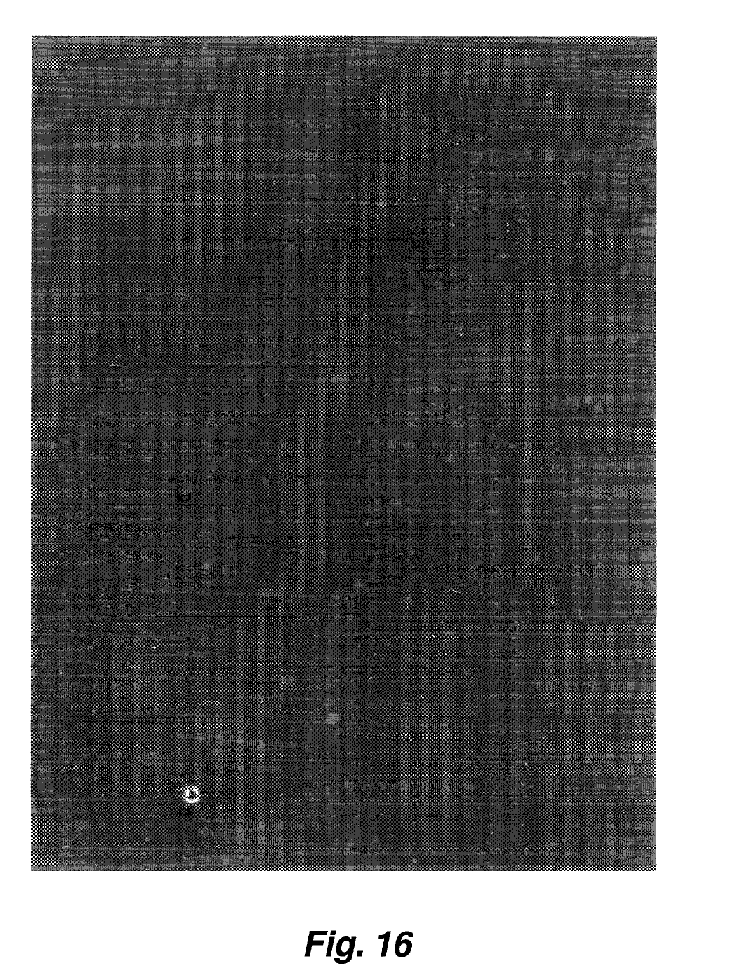

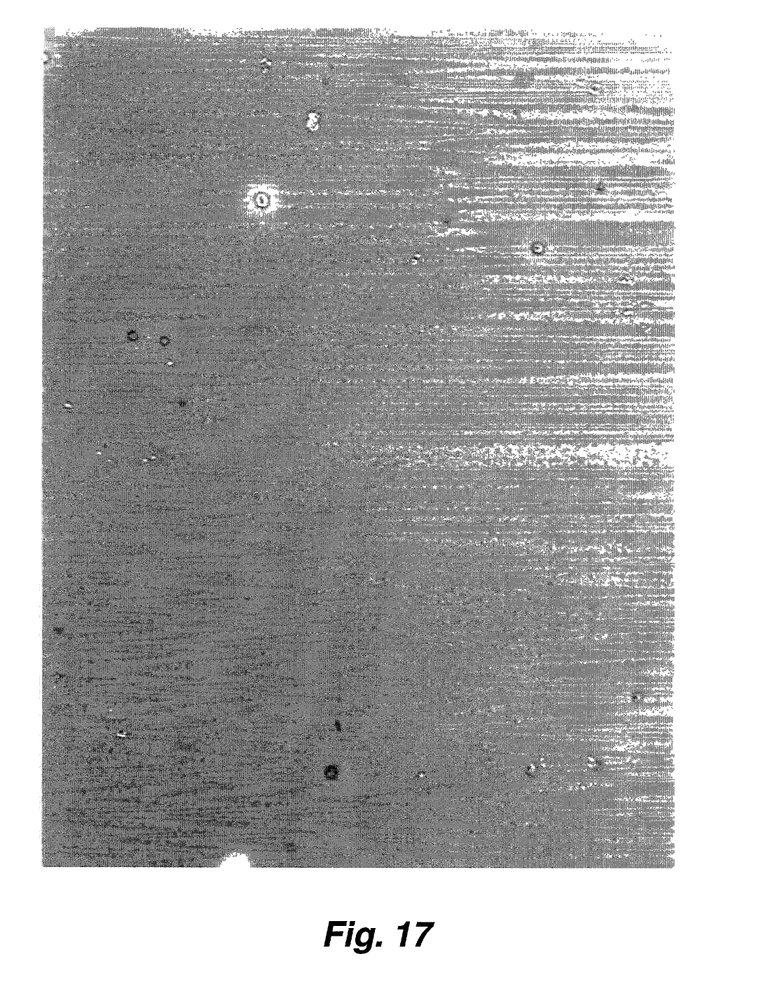

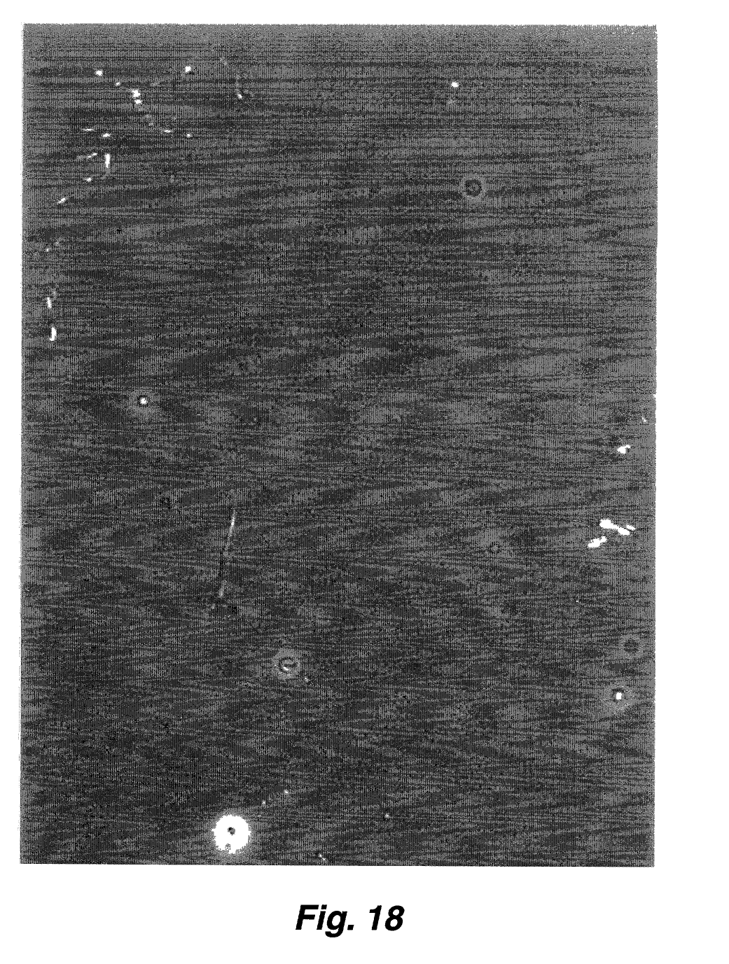

The eight ethanol solutions were spun cast on silicon wafer chips at 25 degrees Celsius. Solid dispersion thin films were produced as the ethanol evaporated. Photographs using a digital camera were taken, see FIGS. 6 and 8. In addition, the silicon wafer chips were analyzed using an optical microscope, with a magnification of 125×, which generated optical micrographs of the thin films, see FIGS. 7 and 9 through 18 (9-18).

The results indicate that the optical micrographs at 125× show that sulfisoxazole:polyvinylpyrrolidone of 1:3 were completely miscible or amorphous or crystals are too small to be detected at a magnification of 125× and at the 1:10 ratio contained high population of drug particles in the background at 25 degrees Celsius. These findings were consistent with the X-ray diffractograms determined by Sekikawa, H.; Nakonoa, M.; Arita, T., “Inhibitory Effect of Polyvinylpyrrolidone On The Crystallization of Drugs,” Chem. Pharm. Bull., 26, 118-126 (1978).

### EXAMPLE 2

The invention was also tested on a system of griseofulvin/polyethylene glycol 6000 in ethanol. The optical micro graph showed that 5 w/w % griseofulvin/polyethylene glycol 6000 in ethanol is a solid solution at 25 degrees celsius. This high dissolution characteristic was constant with the results obtained using a different process and reported in Chiou, W. L.; Riegelman, S. “Preparation and Dissolution Characteristics of Several Fast-Release Solid Dispersions of Griseofulvin,” J. Pharm. Sci., 58, 1505-1509 (1969).

### EXAMPLES 3 AND 4

The invention was also tested on the following two systems: 1) keptoprofen/phosphatidylcholine in xylene; and 2) flurbiprofen/phosphatidylcholine in xylene. The optical micrographs demonstrate that 50 mol % keptoprofen/phosphatidylcholine in xylene and 50 mol % flurbiprofen/phosphatidylcholine in xylene are amorphous. These results are consistent with the XRD patterns generated using a different technique and reported in Fujii, M.; Terai, H.; Mori, T.; Sawaada, Y.; Matsumoto, M., “The Properties of Solid Dispersions of Indomethacin, Ketoprofen and Flurbiprofen in Phosphatidylcholine,” Chem. Pharm. Bull., 36, 2186-2192 (1988).

In conclusion, the above examples using the invention were confirmed using less efficient and traditional techniques, and thus the invention has been validated under different conditions.

It is to be understood that the present invention is not limited to the embodiment described above, but encompasses any and all embodiments within the scope of the following claims.

I claim:

1. A chemical screening method comprising the steps of:
preparing a plurality of solutions each containing a different molar weight ratio of an active ingredient to a carrier molecule in a solvent;
placing at least one drop of each said solution on at least one flat and reflective substrate to enhance a constructive interference and a destructive interference of a light wave propagating through a solid dispersion thin film;
spin casting said flat and reflective substrate with each said solution using a conventional spin-casting apparatus at a specific temperature and a specific pressure until the solvent has evaporated leaving the solid dispersion thin film;
placing each said flat and reflective substrate containing the solid dispersion thin film in a spectrometric instrument to use a reflective mode to produce a micrograph; and
analyzing the micrograph of each of the solid dispersion thin film to determine the extent of crystallization;
whereby the chemical screening method determines at least the solution of the molar weight ratio of active ingredient to carrier molecule where maximum dissolution and crystallization occur.

2. The chemical screening method of claim 1, wherein the spectrometric instrument is selected from the group consisting of an optical microscope, RAMAN microscope, infrared microscope, scanning electron microscope and atomic force microscope.

3. A chemical screening method comprising the steps of:
a) preparing a plurality of solutions each containing a different molar weight ratio of an active ingredient to a carrier molecule in a solvent;
b) placing at least one drop of each said solution on at least one silicon wafer chip;
c) spin casting the silicon wafer chips with each said solution using a conventional spin-casting apparatus at a specific temperature and a specific pressure until the solvent has evaporated leaving a solid dispersion thin film;
d) placing each silicon wafer chip containing the solid dispersion thin film in an optical microscope to produce an optical micrograph; and
e) analyzing the optical micrograph of each solid dispersion thin film to determine the extent of crystallization;
whereby the chemical screening method determines at least the solution of the molar weight ratio of the active ingredient to carrier molecule were maximum dissolution and crystallization occur.

4. The chemical screening method of claim 3, further comprising the step of selecting said specific active ingredient, which is an organic or inorganic crystalline chemical compound.

5. The chemical screening method of claim 3, wherein said carrier molecule is an organic or inorganic compound selected from the group consisting of cellulose, starches, saccharides, hydrogentated saccharides, fats, glycerine, gums, lecithins, chitosans, gelatins, polymers and surfactants.

6. The chemical screening method of claim 3, further comprising the step of selecting the specific solvent based on a determination of the solubility of the active ingredient and the carrier molecule.

7. The chemical screening method of claim 3, wherein said solvent is selected from the group consisting of water, N,N-Dimethylformamide (DMF), N,N-Dimethylacetamide (DMA), methyl sulfoxide (DMSO), acetone, acetonitrile, methanol, ehtanol, isopropanol, n-butanol, tetrahydrofuran (THF), 4-methyl-2-pentanone (MIBK), 2-butanone (MEK), toluene, heptane, cyclohexane, ethyl acetate, n-butyl acetate, isopropyl acetate, and 2-methyltetrahydrofuran.

8. The chemical screening method of claim 3, further comprising the step of using the silicon wafer chip, which has a flat and reflective surface to maximize use of an optical micrograph, RAMAN microscopy, infrared microscopy, electron microscopy, spectroscopy, X-ray diffraction, dielectric measurements and thermal analysis.

9. The chemical screening method of claim 3, further comprising the step of preparing said series of solutions through conventional laboratory methods.

10. The chemical screening method of claim 3, further comprising the step of preparing said series of solutions through automation using at least a solid dispenser and at least a liquid dispensor.

11. The chemical screening method of claim 3, wherein the preferred molar weight ratios of said active ingredient to said carrier molecule are 1:10, 1:9, 1:8, 1:7, 1:6, 1:5, 1:4, 1:3, 1:2, 1:1, 2:1, 3:1, 4:1, 5:1, 6:1, 7:1, 8:1, 9:1 and 10:1.

12. The chemical screening method of claim 3, wherein said active ingredient and said carrier molecule are completely co-dissolved in said solvent under a temperature in the range between substantially zero (0) degrees celsius and the lowest among the boiling point of said solvent, the melting point of said active ingredient or the melting point of said carrier molecule.

13. The chemical screening method of claim 12, wherein said active ingredient and said carrier molecule are completely co-dissolved under a pressure of substantially one (1) atmosphere.

14. The chemical screening method of claim 3, wherein a temperature is maintained in the range between about zero (0) degrees celsius and the lowest among the boiling point of said solvent, the melting point of said active ingredient or the melting point of said carrier molecule during spin-casting.

15. The chemical screening method of claim 3, wherein a pressure of substantially one (1) atmosphere is maintained during spin-casting.

16. The chemical screening method of claim 3, wherein a rotational speed is maintained in a range of one (1) to 5,000 rotations per minute during spin-casting.

17. The chemical screening method of claim 3, further comprising the step of using ellipsometry to determine the film thickness to ensure the accuracy of X-ray diffraction, RAMAN microscopy, infrared microscopy, spectroscopy and the dielectric.

18. The chemical screening method of claim 3, further comprising the step of using RAMAN microscopy, atomic force microscopy, electron microscopy, spectroscopy, X-ray diffraction, dielectric measurements and thermal analysis to confirm and improve the results obtained using optical microscopy;

19. The chemical screening method of claim 3, further comprising the step of using visual examination of the solid dispersion thin films for determining morphology and color.

20. The chemical screening method of claim 3, further comprising the step of constructing an equilibrium phase diagram for each solution wherein the temperature is plotted on a Y axis and the active ingredient to carrier ratios are plotted on an X axis.

21. The equilibrium phase diagram of claim 20, further including the step of constructing at least one solubility limit curve.

22. The chemical screening method of claim 3, further comprising the preparation of a mosaic phase diagram by horizontally placing the optical micrographs sequentially from lowest to highest molar weight ratio across the X-axis of an equilibrium phase diagram at a given temperature found on the Y axis and repeating the process until all micrographs at any subsequent temperatures are placed in the proper orientation on said X-axis and said Y-axis.
